(19) United States
(12) Patent Application Publication
(10) Pub. No.: US 2024/0343235 A1
(43) Pub. Date: Oct. 17, 2024

(54) METHOD FOR OPERATING A WORKING DEVICE AND WORKING DEVICE

(71) Applicant: Vorwerk & Co. Interholding GmbH, Wuppertal (DE)

(72) Inventors: Jascha Bartels, Essen (DE); Fabian Engels, Solingen (DE); Markus Wallentin, Essen (DE)

(21) Appl. No.: 18/370,424

(22) Filed: Sep. 20, 2023

(30) Foreign Application Priority Data
Sep. 26, 2022 (EP) 22197782.0

(51) Int. Cl. B60T 8/58; A47L 9/14; A47L 9/28; A47L 11/28; A47L 11/40; B60T 8/17; B60T 8/171; B60T 8/172

(52) U.S. Cl. CPC B60T 8/58; A47L 9/14; A47L 9/2805; A47L 9/2852; A47L 11/28; A47L 11/4011; A47L 11/4083; B60T 8/1701; B60T 8/171; B60T 8/172; A47L 2201/04; B60T 2201/022; B60T 2210/32; B60T 2250/04

(57) ABSTRACT

A method for operating a working device and a working device. A working device, in particular for industrial applications, and a method for operating a working device, in which the operational safety and operational reliability are increased, are realized by carrying out at least the following method steps:
detecting a safety-relevant operating situation using at least one sensor system of the working device,
initiating a braking process, the braking process including using at least one drive motor of the working device to reduce speed when a critical operating situation has been detected,
processing of at least one driving parameter determined after initiating the braking process,
selecting between a continuation of the braking process or the initiation of an emergency braking process depending at least on the processed driving parameter.

### CROSS REFERENCE TO RELATED APPLICATIONS

This application claims the benefit of priority under 35 U.S.C. § 119 to European Patent Application No.: 22197782.0, filed Sep. 26, 2022, the contents of which is incorporated herein by reference in its entirety.

### FIELD

The invention relates to a method for operating a working device, in particular a cleaning device for autonomous cleaning of a processing environment, wherein the working device is designed to move autonomously in a processing environment.

### BACKGROUND

The statements in this section merely provide background information related to the present disclosure and several definitions for terms used in the present disclosure and may not constitute prior art.

A large number of different types of working devices are conventionally known. Such working devices are designed to move autonomously in a processing environment and to perform work tasks. Examples of such working devices are cleaning devices that perform cleaning tasks in a processing environment, transport robots in warehouse logistics or security robots that are used for monitoring purposes. For example, a cleaning device is designed as a suction robot, mopping robot or suction and mopping robot. Typically, such working devices have at least one control device, which comprises a data processing device, and which uses a plurality of sensors to ensure navigation of the working device in the processing environment and to control the completion of working tasks in the processing environment.

Working devices designed as cleaning devices that are suitable for commercial applications usually have a larger volume, higher weight, higher movement speeds and more power compared to cleaning devices used in households. In addition, increased requirements are placed on operating safety, e.g. with regard to the risk of falling on edges and stairs and in the event of contact with persons or other working devices.

It is therefore of increased importance for the operational safety of a working device that, when an obstacle or a critical operational situation is detected, an immediate reaction of the moving working device is required in order to prevent damage in the vicinity of the working device and/or damage to the working device. An objective of the present disclosure is therefore based on the task of specifying a method for operating a working device and a working device, in particular for industrial applications, by means of which the operational safety and operational reliability are increased.

### SUMMARY

The aforementioned objective of the present disclosure is solved with a method according to a method for operating a working device, wherein the working device is arranged to move autonomously in a processing environment. This method at least comprises the following method steps:
Detection of a safety-relevant operating situation using at least one sensor system of the working device,
Initiating a braking process, the braking process including using at least one drive motor of the working device to reduce speed when a critical operating situation has been detected,
Processing at least one driving parameter determined after initiating the braking process, and
Selecting between a continuation of the braking process or the initiation of an emergency braking process depending at least on the processed driving parameter.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a perspective view of a working device in a processing environment according to the teachings of the present disclosure;

FIG. 2 shows an example of a schematic sequence of a method according to the teachings of the present disclosure; and

FIG. 3 shows another embodiment of a schematic flow of a method according to the teachings of the present disclosure.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, the working device is designed to move autonomously in a processing environment. According to one aspect of the present disclosure, the method comprises at least the following method steps:
detecting a safety-relevant operating situation using at least a first sensor system of the working device,
initiating a braking process, the braking process including using at least one drive motor of the working device to reduce speed when a critical operating situation has been detected,
Processing at least one driving parameter determined after initiating the braking process,
selecting between a continuation of the braking process or the initiation of an emergency braking process depending at least on the processed driving parameter, and in particular
Operating the working device based on the selection.

The working device is designed for autonomous locomotion in a processing environment and for completing work tasks. For example, the working device is designed as a cleaning device, transport device in transport logistics or security robot for environmental monitoring.

Preferably, the working device is designed as a cleaning device for cleaning a processing environment. The working device designed as a cleaning device is advantageously a cleaning device with a suction and/or mopping function, such as a suction robot, a mopping robot or a suction and mopping robot.

The method for operating a working device comprises detecting a safety-relevant operating situation using at least one sensor system of the working device. Safety-relevant operating situations are, for example, situations in which the sensor system required for navigation of the working device, in particular at least one sensor of the sensor system, detects, for example, the risk of the working device being damaged and/or of the working device causing damage in the processing environment. For this purpose, it is provided, for example, that the control device of the working device continuously processes sensor information, for example data, signals or measured values, and detects a safety-relevant operating situation on the basis of predetermined criteria. The detection is advantageously carried out by means of the control device.

If a safety-relevant operating situation is detected by the control device, the control device initiates a braking process. The braking process comprises reducing a speed of the working device using at least one drive motor of the working device. Preferably, the working device comprises at least two drive units, each comprising at least one drive motor, a gearbox and a drive wheel. The drive wheel is drivable by the drive motor. For example, it is provided that initiating the braking process includes driving at least one drive motor or all drive motors such that the drive motor or the drive motors move against the current direction of travel. Typically, such actuation is performed with a corresponding control command or control signal to the drive motors. However, due to the inertia, a drive motor in motion is not able to immediately stop its movement or move in the opposite direction after a corresponding control signal, resulting in a certain time delay.

After the control device initiates the braking process, at least one driving parameter determined after initiating the braking process is processed. The driving parameter can be, for example, a speed and/or a direction of movement and/or another driving parameter. In particular, all parameters that determine the state of movement of the working device and/or that establish a relationship between the movement of the working device and the environment of the working device are suitable as driving parameters.

Depending on the processed driving parameter, for example a speed detected after the start of the braking process, or a result of the processing, a selection is made by the control device in which a decision is made between continuing the braking process or activating an emergency braking process.

Continuation of the braking process is selected, for example, if, using at least the processed driving parameter, it can be assessed by the control device that the occurrence of a damaging event, for example a collision or a fall of the working device, is prevented. The prevention occurs by the braking process leading to a complete stop of the working device before the damage event occurs.

If the control device evaluates the situation using the processed driving parameter in such a way that the braking process does not lead to a timely stop of the working device, i.e. the occurrence of the damage event cannot be prevented by the braking process, the selection of the triggering of an emergency braking process is made. After the selection, the working device is operated on the basis of the selection, i.e. either the braking process is continued or the emergency braking process is triggered.

Preferably, the working device is set up in such a way that it performs a safety shutdown after the emergency braking process has been triggered and after coming to a complete stop, which in particular can only be deactivated manually by a user.

In order to meet safety requirements, it is advantageously provided—as explained above—that after an emergency braking process has been carried out, working device performs a safety shutdown which no longer permits normal operation and which must be deactivated by a user. This ensures that the cause of the safety-relevant operating situation has been eliminated before a user resumes operation, or that the working device has been returned to a safe environment.

Compared to the prior art, the present disclosure has the advantage that not every safety-relevant situation detected by the control device leads to an emergency stop of the working device, which requires a safety shutdown and interaction with a user. In accordance with the present disclosure, it is namely provided that the effectiveness of the measure taken, in this case the braking process, is checked during the braking process on the basis of driving parameters in order to be able to trigger the emergency braking process as part of a further escalation stage. This step-by-step procedure increases the autonomy of the working device and minimizes avoidable interactions between a user and the working device.

According to one aspect of the present disclosure, the method provides that the recognition of a safety-relevant operating situation is performed using sensor information from at least one sensor or a plurality of sensors of the sensor system. The sensor system of the working device is designed, for example, in such a way that the working device can move autonomously in a processing environment using the sensor system. The sensor system is preferably designed to be redundant in order to be able to compensate for the failure of a sensor or individual sensors without jeopardizing the safety of the operation of the working device. The sensor information is, for example, data, signals or measured values of at least one sensor or several sensors.

Preferably, the detection of a safety-relevant operating situation is performed using at least one fall sensor and/or at least one collision sensor. For example, the device has a plurality of fall sensors, which are advantageously designed as distance sensors and are arranged distributed on the underside of the housing. The fall sensors continuously detect the distance of the housing to a surface, e.g., a hall floor, on which the working device is moving. If a significant increase in the distance is detected, the fall sensor or the control device can use it to detect a step in the surface, such as the end of a platform or other ledge, that could pose a fall risk to the working device.

It is provided that the camber sensor is designed, for example, as an optical sensor, an acoustic sensor or other sensor that is suitable for measuring a distance to a surface. The use of non-imaging sensors with which a distance can be determined has proven to be advantageous, since their measured values can be processed more quickly and unambiguously than, for example, the measured values of imaging sensors. The resulting time savings can be decisive, especially for safety-relevant functions.

A collision sensor has, for example, an imaging sensor and/or a laser distance sensor. Advantageously, the collision sensor can be used to continuously detect the environment of the working device, for example in at least one plane, and obstacles can be detected or distances to obstacles can be determined or calculated. Preferably, the collision sensor is also suitable for mapping the processing environment by storing the sensor information and, in particular, linking it to position data. Safety-relevant operating situations can also be detected by means of a collision sensor or a plurality of collision sensors, for example when a person, a vehicle or another working device moves quickly towards the working device or crosses its path of travel.

In order to be able to advantageously evaluate the success of the braking process, it has proven to be advantageous according to a further embodiment of the method if it is provided that at least a speed and/or a direction of movement and/or a distance to an obstacle and/or a distance to a step in the processing environment and/or a distance of the center of gravity of the working device to a step is processed as a driving parameter. The driving parameter is processed in such a way that it is possible for the control device to evaluate the likelihood of success of the braking process. For example, it is also provided that a plurality of the aforementioned driving parameters are processed in order to be able to evaluate the probable success of the braking process.

Preferably, at least one driving parameter, for example the speed, is determined after a predetermined time has elapsed after the braking process is initiated. For this purpose, the initiation of the braking process triggers the start of a time measurement by the control device. After the predetermined time has elapsed, at least one or more driving parameters are determined and processed in order to be able to select between continuing the braking process or activating the emergency braking process.

In particular, it is provided that the predetermined time, i.e. the time period after the initiation of the braking process, after which the driving parameter or parameters is or are determined, is selected such that a damage event has not yet occurred at undiminished speed of the working device. For example, during processing, the distance to an obstacle or the distance to a step is taken into account by the control device for determining or selecting the time, for example from a plurality of times held in a memory. In the event that the critical operating situation has been detected using a fall sensor, it is provided in particular that the time is set or selected such that the center of gravity of the working device has not yet exceeded a step.

Alternatively, it is also preferably provided that the time after which at least one or more driving parameters is or are determined after the start of the braking process is defined as a fixed time period, for example a time between 3 milliseconds and 15 milliseconds. A time period between 5 milliseconds and 10 milliseconds has proven to be advantageous. After this time lapse, a sufficient assessment of the probable success of the braking process can usually already be made.

In particular, it is provided that the driving parameter(s) is/are determined using one or more sensors of the sensor system of the working device that are present in the working device anyway for implementing the autonomous navigation of the working device. For example, according to a further embodiment, it is provided that the determination of the current speed as a driving parameter is performed using a displacement sensor. For example, the displacement sensor comprises at least one sensor or a plurality of sensors in at least one drive wheel, preferably in each drive wheel present. Alternatively or additionally, it is provided that the determination of the speed is performed using an inertial measurement unit and/or a gyro sensor.

In particular, in order to reduce the processing times, it has been found to be advantageous according to a further embodiment if it is provided that the processing of the at least one driving parameter or the processing of a plurality of driving parameters comprises the comparison of at least one driving parameter with at least one driving parameter setpoint held in a memory. The driving parameter setpoints are kept ready in a memory of the control device, for example. During processing, the determined driving parameter is compared, for example, with a driving parameter setpoint determined for comparable situations. If the currently determined driving parameter is greater than the driving parameter setpoint, for example, this can be a criterion for indicating that the braking process will not lead to prevention of the damaging event, so that a selection of activation of the emergency braking function can then be made on this basis.

If, for example, the currently determined driving parameter is smaller than the driving parameter setpoint used for the adjustment, this can be a criterion for the braking process to prevent the damaging event. The driving parameter setpoint can, for example, represent a speed that must already have been reached at a distance to an obstacle or step that has also been determined at this point in time in order to implement a braking process that prevents a damaging event before the obstacle or step is reached.

It is preferred that the processing of the at least one driving parameter includes comparing the speed after a predetermined time after initiating the braking process with at least one speed setpoint stored in a memory as a driving parameter setpoint. For example, it is provided that at least one driving parameter setpoint stored in the memory represents at least a percentage reduction of an initial speed (for example the speed at the start of the braking process) after a predetermined time. Advantageously, the driving parameter setpoint is determined or empirically determined in such a way that a predetermined percentage reduction of the initial speed must have occurred after a predetermined time in order to be able to assess that the braking process will lead to a prevention of the damaging event.

However, it has proved advantageous if, according to a further embodiment, it is provided that different driving parameter setpoints for different configurations of the working device are kept available in the memory, and that the processing of the driving parameter, i.e. the comparison with the stored driving parameter setpoints, takes place taking into account a current configuration of the working device. The configuration of the working device, for example the actual dimensions of the housing, but also the number of energy storage devices used, influence, for example, the stopping distance of a working device after a braking process has been initiated.

It is provided that the working device records its current configuration, for example by means of sensors, and takes this into account when processing the driving parameter, in particular selecting the driving parameter setpoints to be compared in such a way that the driving parameter setpoints for the current configuration are used for processing. The set driving parameter values have been determined empirically for different boundary conditions, e.g. stopping distances for different weights or speeds, or have been determined mathematically for different boundary conditions or by simulation.

Alternatively or additionally, it is provided that different driving parameter setpoints for different processing environments are kept available in the memory. For example, processing environments, in particular the surfaces, have different properties that have different frictional properties in interaction with the drive wheels of the working device. These in turn have an influence on the stopping distance, so that it is also provided that different driving parameter setpoints are used for the calibration depending on the processing environment in which the working device is currently being used. In this way, the influence of particularly smooth or particularly rough floor surfaces on the stopping distance can be taken into account when evaluating the success of the braking process.

Advantageously, a further embodiment provides that the different configurations of the working device take into account different housing dimensions and/or the position of the center of gravity in the housing and/or the presence of an accessory component mounted on the working device and/or the filling level of a cleaning water tank and/or the filling level of a dirt collection tank. For example, the working device detects that an accessory component, for example a tool, a water tank or the like, is mounted on the housing, which changes the position of the center of gravity of the working device. Different driving parameter setpoints are then used for the adjustment during processing than would be the case if the accessory component, an additional battery or the like were not present. The same applies to the filling level of a cleaning water tank or the filling level of a dirt collection tank, both of which influence the position of the center of gravity in the housing.

For example, if a fall on a step is to be prevented, the position of the center of gravity in the housing of the working device can have a significant influence on how much time is left for the braking process before the center of gravity has passed over the step. Consequently, knowledge, particularly of the location of the center of gravity of the working device in the housing, has a significant impact on the evaluation of whether or not the braking action will prevent a damaging event from occurring. Preferably, separate driving parameter setpoints are kept in memory for all these configurations or a combination thereof.

It is also provided that weighting factors are kept ready for certain configurations. For each driving situation, e.g. as a combination of speed and distance to the obstacle, there is, for example, only one driving parameter setpoint, which is, however, then recalculated or adjusted by the control device taking into account weighting factors representing the configuration of the working device. It is also provided that one or more weighting factors will be applied to the driving parameter as it is processed.

A further embodiment provides that a selection or result value is generated during processing, in particular as a result of processing, and that the selection value represents a statement as to whether the occurrence of a damaging event resulting from the safety-relevant operating situation can be prevented by the braking process. Based on the selection value, the control device then selects whether the emergency braking process is activated or the braking process can be continued. After the selection, the working device is operated with the selected process.

Furthermore, according to a further embodiment, it is provided that the processing of the driving parameter includes the determination of a probability, in particular a probability representing the prevention of a damaging event with the braking process or the occurrence of the damaging event if the braking process is continued. For example, it is provided that the selection is then made based on the determined probability. In particular, it has been defined in advance at which probability the braking process is continued and at which probability the emergency braking function is activated. It is provided that at least one driving parameter or a plurality of driving parameters is/are taken into account when determining the probability. The driving parameter or parameters include, for example, the current speed, the course of a speed and/or the distance to obstacles or steps. Furthermore, the current configuration of the working device may be taken into account.

As already described, the selection of the activation of the emergency braking process takes place when, depending on the processing of the driving parameter or a plurality of driving parameters, the occurrence of a damaging event cannot be prevented with the braking process, i.e. the evaluation shows that the braking process will probably not be successful.

The selection of the continuation of the braking process takes place if the evaluation within the processing of the driving parameter shows that the occurrence of a damaging event can be prevented with the braking process. Preferably, it is provided that after a selection of the continuation of the braking process, the braking process is continued until the working device comes to a complete stop. For example, after the complete stop, the sensor system of the working device is used to analyze the environment of the working device. If there is no longer a critical operating situation, operation can be continued after the working device has come to a standstill while avoiding the occurrence of the damaging event.

If the critical operating situation is a step, for example, the working device is stopped before the center of gravity protrudes beyond the step. Subsequently, for example, the direction of movement can be changed and the cleaning process can be continued, in particular parallel to the step. The control unit is designed and set up in particular in such a way that a detected, safety-relevant operating situation can be stored at least temporarily. Storing the operating situation preferably has the effect that the cause, for example a step, is at least temporarily disregarded for further operation or further completion of a processing task, since, for example, a change of direction has been completed and a movement parallel to the step now takes place. For example, the sensor information of at least one sensor is thereby at least temporarily disregarded, in particular for the detection of safety-relevant operating situations. For example, when moving parallel to a step, a laterally arranged fall sensor continues to report the step, but the control unit can evaluate this sensor information as uncritical due to the stored event and the change of direction that has taken place and continue operation.

This provides the advantage that the working device can be operated very close to building edges, for example steps, without activating an emergency braking process. This adapted behavior results in greater autonomy of the working device while at the same time extending the working spectrum.

According to a further embodiment, it has turned out to be advantageous if the initiation of the braking process comprises the control of at least one drive motor, in particular all drive motors, with a control command that causes the drive motor or the drive motors to execute a travel movement that has the goal of reducing the speed of the working device. In particular, reducing the speed of the working device to a standstill as quickly as possible is the objective. For example, the drive motor(s) is/are controlled to perform a driving movement against the current direction of movement. Alternatively, it is provided that initiating the braking process involves interrupting the voltage supply to the drive motor or motors.

It has also been found to be advantageous if it is provided that the triggering of an emergency braking function includes the triggering of a separate emergency braking system. In particular, the emergency braking system is designed in such a way that, after triggering, the mechanical application of a braking force with at least one braking element is effected at least indirectly on a moving component. The moving component preferably serves to effect movement of the working device, for example a rotor of a motor, a motor shaft or a component of a gearbox. It is also provided that at least one brake ring is arranged on the motor shaft, and that the braking element is configured to act on the brake ring. By the mechanical action of the braking element on a moving, in particular rotating, component, a drive unit of the working device can be braked or blocked immediately.

It is preferably provided that each drive unit has at least one braking element, which preferably acts on an external rotor of a motor, at least indirectly on a motor shaft or on a brake ring arranged on a motor shaft. As a result, a large effect for braking the working device can be achieved with a relatively small actuating force. Preferably, the working device has two drive units, each of which has a braking element. It is also provided that a braking element acts directly on the running surface or another surface of a drive wheel to inhibit, stop or block a movement of the drive wheel.

A further embodiment of the method provides that the working device has at least two drive units, each with a braking element. Each drive unit has, for example, a drive motor, a gearbox and a drive wheel. The braking element is designed, for example, to act on an external rotor of the motor or at least indirectly on a motor shaft. For example, it is provided that the braking element is always urged by a spring in the direction of the surface of the rotor or the motor shaft, so that the emergency braking system is activated in the de-energized state.

Furthermore, at least one actuator is provided which moves the braking element into a release position when the working device is to be operated in the normal state. This realizes an emergency braking system that is less susceptible to faults.

In particular, it is provided that the triggering of an emergency braking function is selective for at least one drive unit. In this way, in addition to braking the working device, a short-term change of direction can also be generated. If, for example, a drive unit is completely blocked by the emergency brake function, this can lead to a rotation, i.e. an immediate change of direction of the working device, which prevents the occurrence of a damaging event, for example a fall at an edge, by causing the working device to move in a different direction.

In one embodiment of the method, it has been found to be advantageous if the following method steps are also included in the method:
Measuring the time after initiating the braking process;
Determining the current speed after a predetermined time, for example 5 ms, 8 ms or 10 ms, has elapsed after initiating the braking process, the predetermined time being selected such that a damage event has not yet occurred even without reducing the speed, for example the center of gravity of the working device has not yet exceeded a step; and
Comparing the current speed with at least one speed setpoint held in a memory, the speed setpoint having been determined taking into account a specific working device configuration which corresponds to the current working device configuration, and the result of the comparison allowing an evaluation by the control device as to whether the damage event can be prevented with the braking process or not. If the damage event can be prevented, the braking process is continued, if the damage event cannot be prevented, the emergency braking function is triggered.

The aforementioned task is further solved by a working device which is designed and set up for carrying out a method according to at least one of the embodiments described above. Preferably, the control device of the working device is designed and set up in such a way that a method described above can be executed by the control device with the working device. The working device comprises at least one housing, at least one drive unit, at least one sensor system and at least one control device. The drive unit comprises at least one drive motor and at least one drive wheel. Preferably, the drive unit also comprises a transmission. The working device is designed and configured to move autonomously in a processing environment.

The sensor system has at least one sensor or a plurality of sensors. The sensor system is advantageously designed to provide sensor information. The control device controls the autonomous movement and cleaning of a processing environment by the cleaning device. The control device preferably comprises at least one data processing device with at least one processor and at least one memory.

Preferably, the working device comprises at least one second control device. The second control device advantageously has at least one data processing device with at least one processor and at least one memory. The second control device is designed and set up to take over at least some or all of the tasks of the first control device as a redundant system if there is a malfunction in the first control device.

For example, at least or exactly two drive units are arranged on the housing of the working device, each of which has at least one drive motor, in particular an electric motor, and at least one drive wheel. The drive motor is preferably a brushless DC motor, in particular a brushless DC motor designed as an external rotor. The two drive motors of the drive units can be controlled independently of one another. Each drive motor drives at least indirectly at least or exactly one drive wheel. It is also provided, for example, that a gearbox is arranged between the drive motor and the drive wheel of a drive unit.

Furthermore, the working device has at least one energy storage device which is designed for supplying voltage to the working device, in particular for supplying voltage to the control device and in particular to a working tool, in particular a cleaning tool, and is electrically connected in the housing. For example, the energy storage device is designed as an accumulator with at least one cell, in particular a plurality of cells.

Further advantageous embodiments of the present disclosure are apparent from the following description of figures. In the various figures in the drawing, the same parts are always given the same reference numbers.

Regarding the following description, it is claimed that the present disclosure is not limited to the embodiments and thereby not limited to all or several features of described feature combinations, rather each individual partial feature of the/each embodiment is also of importance for the subject matter of the present disclosure detached from all other partial features described in connection therewith for itself and also in combination with any features of another embodiment.

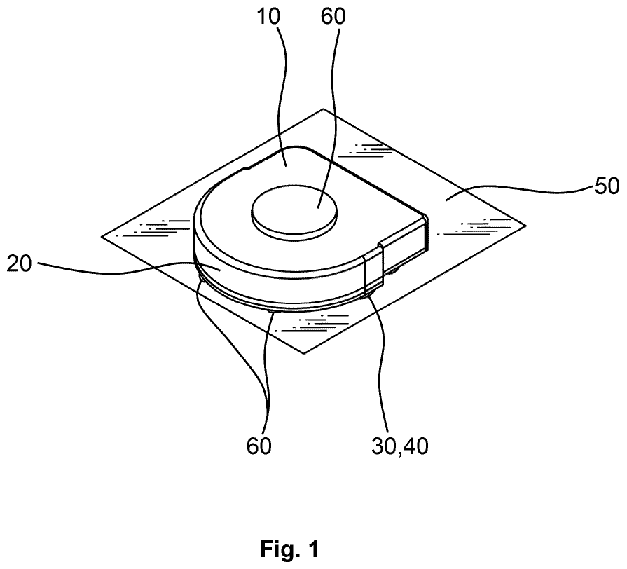

FIG. 1 shows an embodiment of a working device 10 configured as a cleaning robot. The working device 10 has at least one housing 20 with two drive units 30 and at least one control device. The drive unit 30 has at least one drive motor and at least one drive wheel 40. The working device 10 is configured and arranged to autonomously move in a processing environment 50. The working device 10 comprises a sensor system 60.

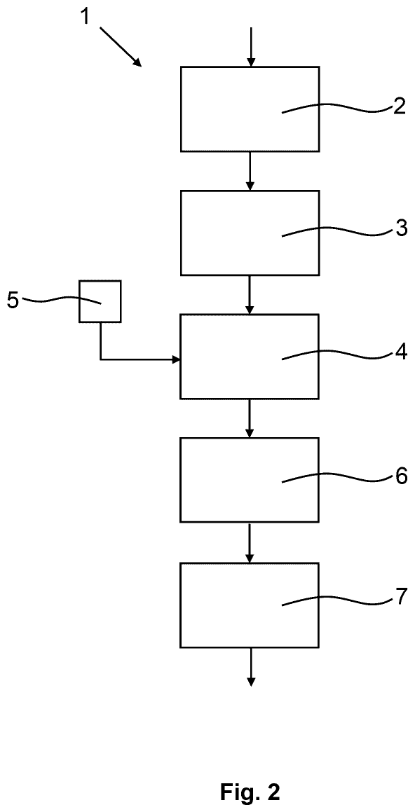

FIG. 2 shows an embodiment of a schematic sequence of a method 1 for operating a working device 10. The method 1 comprises the detection 2 of a safety-relevant operating situation using at least one sensor system 60 of the working device 10. For example, a fall sensor is used to detect that the working device 10 is located at a step in the processing environment 50 or is moving towards a step. Subsequently, a braking process is initiated 3, in which at least one drive motor of the working device 10 is controlled with a travel command to move against the current direction of movement in order to brake the working device 10.

After initiating 3 the braking process, processing 4 of at least one driving parameter 5 detected after initiating 3 the braking process takes place, followed by selecting 6 between continuing the braking process or activating an emergency braking process depending at least on the processed driving parameter 5. Finally, operation 7 of the working device 10 takes place on the basis of the selection, namely continuing the braking process or activating the emergency braking process. Preferably, the method is performed continuously during operation of a working device 10. The sensor system 60 is used to monitor the processing environment 50 during operation for this purpose.

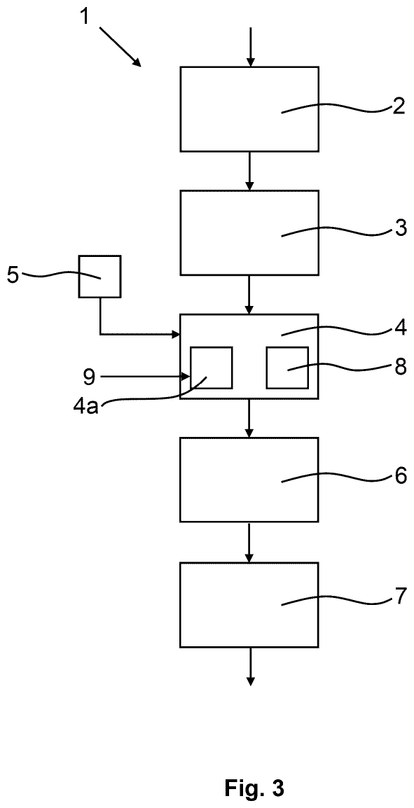

FIG. 3 shows a further embodiment of a schematic sequence of a method 1. First, again, the detection 2 of a safety-relevant operating situation takes place using at least one sensor system 60 of the working device 10. Subsequently, the initiation 3 of a braking process takes place using at least one drive motor of the working device 10 if a critical operating situation has been detected.

Subsequently, processing 4 involves measuring 8 a time lapse in order to detect at least one driving parameter 5 after a predetermined time, in this case 8 ms, has elapsed. The driving parameter 5 is the current speed of the working device 10. Processing 4 comprises comparing 4a of the detected driving parameter 5 with a driving parameter setpoint 9, in this case a speed setpoint, held in a memory. If the detected driving parameter 5 is below the driving parameter setpoint 9, a selection 6 of the continuation of the braking process is made, if the detected driving parameter 5 is above the driving parameter setpoint 9, a selection of the triggering of the emergency braking process is made and subsequently an operation 7 of the working device 10 based on the selection.

The invention is not limited to the embodiments shown and described, but also includes all embodiments having the same effect in the sense of the invention. It is expressly emphasized that the embodiments are not limited to all features in combination, rather each individual sub-feature may also have inventive significance in isolation from all other sub-features. Furthermore, the invention has not yet been limited to the combination of features defined in any embodiment either, but can also be defined by any other combination of certain features of all the individual features disclosed as a whole. This means that in principle virtually any individual feature of any embodiment can be omitted or replaced by at least one individual feature disclosed elsewhere in the application. In other words, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A Method for operating a working device, wherein the working device is arranged to move autonomously in a processing environment, at least comprising the following method steps:
Detection of a safety-relevant operating situation using at least one sensor system of the working device,
Initiating a braking process, the braking process including using at least one drive motor of the working device to reduce speed when a critical operating situation has been detected,
Processing at least one driving parameter determined after initiating the braking process,
Selecting between a continuation of the braking process or the initiation of an emergency braking process depending at least on the processed driving parameter.

2. The method according to claim 1,
characterized in that
the detection is carried out using sensor information of at least one sensor or a plurality of sensors of the sensor system.

3. The method according to claim 1, wherein
at least one of at least a speed or a direction of movement or a distance to an obstacle or a distance, to a step is processed as a driving parameter.

4. The method according to claim 1, wherein
the driving parameter is determined after a predetermined time has elapsed after the initiation of the braking process.

5. The method according to claim 1, wherein
the current speed is determined as a driving parameter, and in that the current speed is determined using at least one of a displacement sensor or an inertial measurement unit or a gyro sensor.

6. The method according to claim 1, wherein
the processing of the at least one driving parameter comprises the comparison with at least one driving parameter setpoint stored in a memory.

7. The method according to claim 5,
characterized in that
at least one driving parameter setpoint represents at least one of at least one speed value which has been determined taking into account a configuration of the working device at least a percentage reduction of an output speed by a predetermined value after a predetermined time.

8. The method according to claim 5, wherein
different driving-parameter setpoints for different configurations of the working device are kept ready in the memory, and wherein the processing of the driving parameter takes place taking into account a current configuration of the working device.

9. The method according to claim 1, wherein
a selection value is generated in the course of the processing, and in wherein the selection value represents a statement as to whether the occurrence of a damaging event resulting from the safety-relevant operating situation can be prevented by the braking process.

10. The method according to claim 1, wherein
the processing includes determining a probability representing the prevention of a damaging event with the braking process or the occurrence of the damaging event if the braking process continues.

11. The method according claim 1, wherein
the selection of the triggering of the emergency braking process takes place if, depending on the processing of the driving parameter, the occurrence of a damaging event cannot be prevented with the braking process.

12. The method according to claim 1, wherein
the selection of the continuation of the braking process takes place if, depending on the processing of the driving parameter, the occurrence of a damaging event can be prevented with the braking process the braking process is continued until a complete standstill of the working device, and that after the standstill of the working device, an operation is continued while avoiding the occurrence of the damaging event.

13. The method according to claim 1, wherein
the initiation of the braking process comprises the control of at least one drive motor with a control command which causes the drive motor er the drive meters to execute a driving movement which has as its objective a reduction in the speed of the working device or in that the initiation of the braking process includes an interruption of the voltage supply to the drive motor or the drive motors.

14. The method according to claim 1, wherein
the triggering of the emergency brake function includes the triggering of a separate emergency brake system.

15. A working device, having at least one housing, at least one drive unit, at least one environment sensor and at least one control device, the drive unit having at least one drive motor and at least one drive wheel, the working device being designed and set up to move autonomously in a processing environment, wherein
the working device is constructed and arranged for carrying out a method according to claim 1.

16. The method according to claim 2, wherein the use of sensor information of at least one of at least one fall sensor or at least one collision sensor is carried out.

17. The method according to claim 4, wherein the time is selected such that, at undiminished speed of the working device, a damage event has not yet occurred after the time has elapsed.

18. The method according to claim 8, wherein the different configurations of the working device take into account at least one of different housing dimensions or the position of the center of gravity in the housing or the presence of an accessory component mounted on the working device or the filling level of a cleaning water tank or the filling level of a dirt collection tank.

19. The method according to claim 9, wherein the generation of the selection value includes a comparison with a driving parameter setpoint held in a memory.

20. The method according to claim 4, wherein the emergency brake system after a triggering causes the mechanical application of a braking force with at least one brake element to at least one component moving to cause a movement of the working device or includes the interruption of the voltage supply of the drive motor or the drive motors.

21. The method according to claim 6,
characterized in that
at least one driving parameter setpoint represents at least one of at least one speed value which has been determined taking into account a configuration of the working device or at least a percentage reduction of an output speed by a predetermined value after a predetermined time.
